(19) United States
(12) Patent Application Publication
(10) Pub. No.: US 2020/0156967 A1
(43) Pub. Date: May 21, 2020

(54) IONIZED WATER PRODUCING DEVICE

(71) Applicant: UJong LEE, Suwon-si (KR)

(72) Inventor: UJong LEE, Suwon-si (KR)

(21) Appl. No.: 16/233,844

(22) Filed: Dec. 27, 2018

(30) Foreign Application Priority Data
Nov. 16, 2018 (KR) 10-2018-0141890

(51) Int. Cl. C02F 1/48

(52) U.S. Cl. CPC C02F 1/482

(57) ABSTRACT

The present invention relates to an ionized water producing device. The present invention provides an ionized water producing device that can be easily manufactured and assembled by a mold and can be connected to various locations such as a hose, a connection tube and the like so that water can pass between magnetic fields with opposite polarities, which are generated from two or more permanent magnets disposed in the ionized water producing device to produce a large amount of ionized water.

### CROSS-REFERENCE TO RELATED APPLICATIONS

This application claims the benefit of Korean Patent Application No. 10-2017-0141890, filed on 2018 Nov. 16 in the Korean Intellectual Property Office, which is incorporated herein by reference in its entirety.

### BACKGROUND OF THE INVENTION

### 1. Field of the Invention

The present invention relates to an ionized water producing device, and more particularly, to an ionized water producing device that has been developed to allow water to pass between permanent magnets so as to be ionized so that it can be easily manufactured and assembled and the ionization efficiency can be increased.

In addition, the present invention relates to an ionized water producing device that is configured such that water introduced through an inflow port rotates and collides against a nozzle inner peripheral portion by water pressure so as to be primarily ionized while passing through a nozzle unit having an inner peripheral portion formed in a shape which is gradually reduced and then again increased in diameter as it goes toward the top from the bottom, and a pipe conduit having an inflow port and an outflow port is formed in an inverted trapezoidal shape so that water introduced through the inflow port is secondarily ionized through the permanent magnets and is discharged to the outside through the outflow port to provide a large amount of ionized water.

### 2. Description of Related Art

Although Korea is considered to be one of the water-scarce countries in the world, water used for drinking and washing is comparatively abundant. However, directly drinkable water is increasingly becoming scarce due to environmental pollution and it is common that most people takes in, either directly or by boiling, tap water purified through large-scale water intake works and several purification processes.

In recent years, as the incidence of various atopic diseases is high, tap water is not drunken after simply being boiled, but changes occur which include boiling water mixed with various natural materials or medicinal ingredients, using water purifiers, buying mineral water, and the like in order to take in water.

In particular, tap water has a high possibility that various kinds of bacteria or impurities will infiltrate thereinto while water passing through outworn water pipes or dirty water tanks, and thus it is necessary to pay special attention to both drinking and washing.

In consideration of this fact, cases are increasing in which people simply install and use an ionized water producing device that forms a magnetic field in a direction perpendicular to the direction of water flow while water passes between permanent magnets of small sizes to increase the surface tension of water so that the water molecule structure is ion-activated to produce ionized water having a hexagonal ring structure with water molecules composed of hydrogen and oxygen atoms bonded together.

However, a conventional ionized water producing device is designed such that it is mainly mounted in an internal space of a shower. Therefore, there is a need to develop an ionized water producing device that can be more simply and conveniently mounted at a shower hose or a tap faucet, and easily manufactured and assembled.

### SUMMARY OF THE INVENTION

The present invention has been made to solve the above-mentioned problems occurring in the prior art, and it is an object of the present invention to provide an ionized water producing device that is configured such that water introduced through an inflow port rotates and collides against a nozzle inner peripheral portion by water pressure so as to be primarily ionized while passing through a nozzle unit having an inner peripheral portion formed in a shape which is gradually reduced and then again increased in diameter as it goes toward the top from the bottom, and a pipe conduit having an inflow port and an outflow port is formed in an inverted trapezoidal shape so that water introduced through the inflow port is secondarily ionized through the permanent magnets and is discharged to the outside through the outflow port to provide a large amount of ionized water.

To accomplish the above object, the present invention provides an ionized water producing device that is configured such that water introduced through an inflow port of a lower portion of a housing is ionized through permanent magnets while passing through an inner pipe conduit P and then is discharged to the outside through an inflow port, and the inside of the pipe conduit P is configured in such a manner that the structure of an inflow port and an outflow port is formed in an inverted trapezoidal shape so that water introduced through the inflow port is ionized through the permanent magnets 144 and is discharged to the outside through the outflow port to produce a large amount of ionized water.

As described above, the present invention has an advantageous effect in that it can be easily manufactured and assembled by a mold and can be mountedly connected to various locations such as a hose, a connection tube and the like so as to be applied to more locations such as a kitchen sink, a shower and the like to use ionized water.

In addition, the present invention has an advantageous effect in that a flow passage is formed therein to allow water to pass between two or more magnetic fields with opposite polarities so that a large amount of ionized water can be produced in a more stable and efficient manner.

Further, the present invention relates to an ionized water producing device that is configured such that water introduced through an inflow port rotates and collides against a nozzle inner peripheral portion by water pressure so as to be primarily ionized while passing through a nozzle unit having an inner peripheral portion formed in a shape which is gradually reduced and then again increased in diameter as it goes toward the top from the bottom, and a pipe conduit having an inflow port and an outflow port is formed in an inverted trapezoidal shape so that water introduced through the inflow port is secondarily ionized through the permanent magnets and is discharged to the outside through the outflow port to provide a large amount of ionized water.

### BRIEF DESCRIPTION OF THE DRAWINGS

The above and other objects, features and advantages of the present invention will be apparent from the following detailed description of the preferred embodiments of the invention when taken in conjunction with the accompanying drawings, in which:

FIG. 1 is an assembled perspective view showing an ionized water producing device according to an embodiment of the present invention;

FIG. 2 is an exploded perspective view showing an engagement state of a nozzle unit of an ionized water producing device according to an embodiment of the present invention;

FIG. 3 is an exploded perspective view showing an ionized water producing device according to an embodiment of the present invention;

FIG. 4 is an enlarged exploded perspective view showing an ionized water producing device of FIG. 3;

FIG. 5 is a transverse cross-sectional view showing a nozzle unit of an ionized water producing device according to an embodiment of the present invention;

FIG. 6 is a partial perspective and enlarged view showing an inner state of a nozzle unit of an ionized water producing device according to an embodiment of the present invention;

FIG. 7 is a partial cut-away perspective view showing an ionized water producing device according to an embodiment of the present invention;

FIG. 8 is a transverse cross-sectional view showing an ionized water producing device according to an embodiment of the present invention; and

FIG. 9 is a top plan view showing an inflow port of an ionized water producing device of the present invention;

FIG. 10 is a top plan view showing an outflow port of an ionized water producing device of the present invention;

FIG. 11 is a front view showing an inner configuration of an ionized water producing device of the present invention;

FIG. 12 is a longitudinal cross-sectional view showing an inner state of a flow channel of an ionized water producing device, taken along the line A-A of FIG. 11;

FIG. 13 is a front view showing an inner configuration of an ionized water producing device of the present invention; and

FIG. 14 is a cross-sectional view showing the state of an insert-molded inside of a lower connection unit of an ionized water producing device, taken along the line B-B of FIG. 13.

### EXPLANATION ON SYMBOLS

1: ionized water producing device
11: lower connection unit
   111: first O-ring 112: first O-ring insertion groove
   113: second engagement part 115: fourth O-ring insertion groove
      116: through-hole
12: upper connection unit
   121: second O-ring 122: second O-ring insertion groove
   13: nozzle unit
      131: nozzle inner peripheral portion
   14: housing
      141: flow passage 142: main partition wall
      143: reinforcing rib 144: permanent magnet
      145: magnet insertion opening 146: horizontal reinforcing rib
      147: screw thread
   15: metal tube
   16: upper end cap

### DETAILED DESCRIPTION OF THE PREFERRED EMBODIMENTS

Hereinafter, a configuration of an ionized water producing device according to the present invention will be described in detail with reference to the accompanying drawings in order for a person of ordinary skill in the art to sufficiently understand and carry out the present invention.

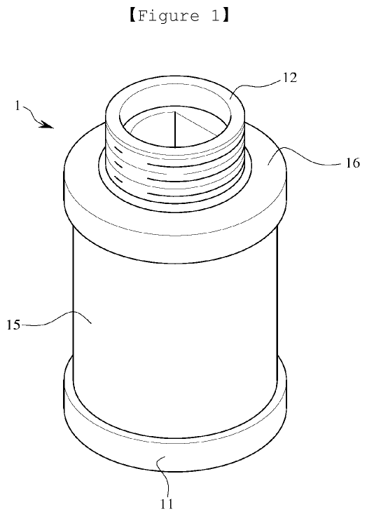

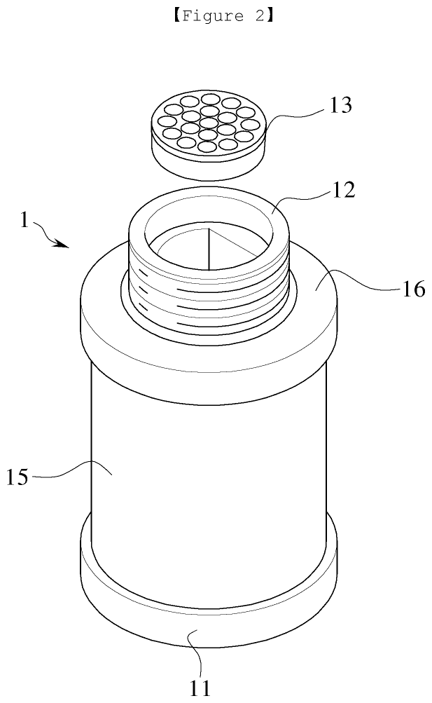

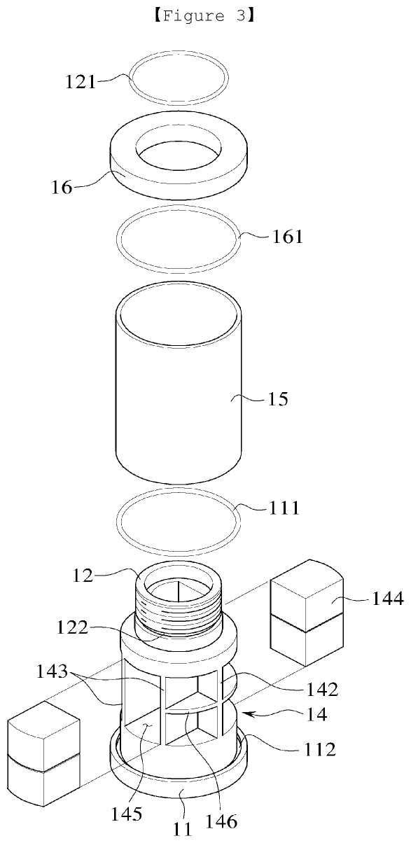

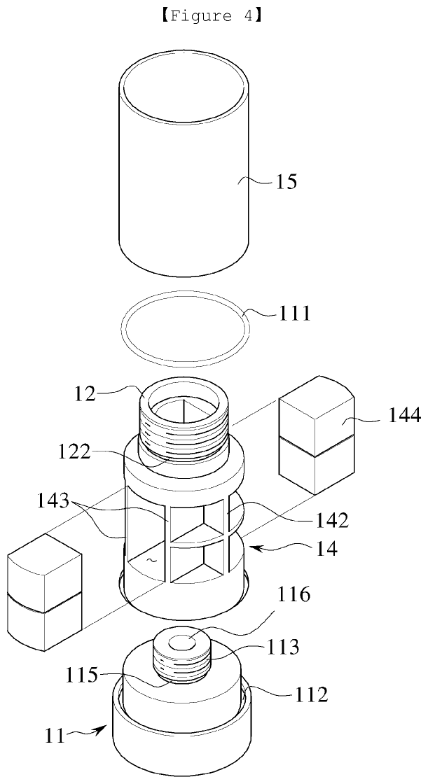

FIG. 1 is an assembled perspective view showing an ionized water producing device according to an embodiment of the present invention, FIG. 2 is an exploded perspective view showing an engagement state of a nozzle unit of an ionized water producing device according to an embodiment of the present invention, FIG. 3 is an exploded perspective view showing an ionized water producing device according to an embodiment of the present invention, and FIG. 4 is an enlarged exploded perspective view showing an ionized water producing device of FIG. 3.

A device 1 for producing ionized water according to an embodiment of the present invention includes a lower connection unit 11, an upper connection unit 12, a nozzle unit 13, a housing 14, a metal tube 15, and an upper end cap 16.

The ionized water producing device 1 allows water to be introduced to one side thereof and vertically pass between permanent magnets with opposite polarities confronting each other to cause water to be ionized and prevent a discharge phenomenon from occurring.

The lower connection unit 11 is opened at a bottom surface thereof and has a screw thread formed on an inner peripheral surface thereof. The lower connection unit 11 has a stepped outer peripheral surface that is increased in outer diameter and bent upwardly at a bottom end thereof to have a first O-ring insertion groove 112 formed in the bent portion to allow a first O-ring 111 to be inserted therein.

The upper connection unit 12 is opened at a top surface thereof and has a stepped outer peripheral surface that is reduced in outer diameter at an upper portion thereof. The upper connection unit 12 has a second O-ring insertion groove 122 formed to be circumferentially depressed on an outer peripheral surface of an upper portion thereof to allow a second O-ring 121 to be inserted therein, and a screw thread formed on the outer peripheral surface of the upper portion thereof so as to be positioned above the second O-ring insertion groove 122.

The nozzle unit 13 has a plurality of through-holes 131 formed therein by molding and calcining precious serpentine and is inserted into the upper connection unit 12 to allow the introduced water to be ionized by increasing the number of frictional rotations of the introduced water while flowing in a zigzag pattern.

The housing 14 includes a main partition wall 142 formed therein in a shape of a vertically erected trapezoidal plate so as to pass through the centers of a pair of vertically spaced apart horizontal disks between the disks, the main partition wall having a flow passage 141 penetratingly formed vertically in the center thereof in a shape of an elongated hole. The housing 14 also includes two pairs of opposed reinforcing ribs 143, each pair of which extends outwardly from the center of the main partition wall so as to be spaced apart from each other, a pair of magnet insertion openings 145, each of which is defined by each pair of the opposed reinforcing ribs 143 and the main partition wall 142 to allow a permanent magnet to be inserted therein, and one or more horizontal reinforcing ribs 146 configured to horizontally interconnect a plurality of openings defined by the two pairs of reinforcing ribs 143 and the main partition wall 142, other than the magnet insertion openings 145. The housing 14 has a screw thread 147 formed on an inner peripheral surface thereof by insert injection molding so as to be engaged with the lower connection unit 11.

The metal tube 15 is formed in a cylindrical shape and is made of metal. The metal tube surrounds the housing 13 and is pressed by the first O-ring 111 at a bottom end thereof.

The upper end cap 16 allows the upper portion of the upper connection unit 12 to penetrate through a central hole thereof so as to be exposed to the outside. The upper end cap has a bottom end that is bent downwardly at an outer peripheral surface thereof to have a third O-ring insertion groove 162 formed in the bent portion to allow a third O-ring 161 to be inserted therein to press a top end of the metal tube 15.

The lower connection unit 11 includes a second engagement part 113 formed on a top surface thereof so as to be engaged with the screw thread 147 formed on the housing 14 by insert injection molding so that the flow passage 141 penetratingly extends downwardly.

The screw thread 147 is formed on an inner peripheral surface of the housing 14 thereof by insert injection molding, but not conventional plastic injection molding so that the engagement strength can be increased and damage can be prevented when the screw thread 147 is engaged with the second engagement part 113 of the lower connection unit 11.

In addition, a lower portion of the housing 13 is integrally formed with an upper portion of the lower connection unit 11 so that the flow passage 131 can be formed so as to penetratingly extend downwardly.

FIG. 4 is an exploded perspective view showing an engagement structure of the lower connection unit 11 and the housing 14.

Referring to FIG. 4, the lower connection unit 11 includes: the second engagement part 113 formed protrudingly upwardly from the top surface thereof and having a screw thread formed on an outer peripheral surface thereof so as to be engaged with the first engagement part 147, the screw thread having a lower end formed with an outer peripheral surface that is steppedly decreased and increased in outer diameter; and a through-hole 116 formed vertically penetratingly at the center of the top surface of the second engagement part 113 so as to fluidically communicate with the flow passage 141 so that the second engagement part 113 is fixedly engaged with the screw thread 147 of and the housing 14.

When the housing 14 is engaged with the second engagement part 113 of the lower connection unit 11 by means of the screw thread 147, the engagement strength can be increased and damage can be prevented.

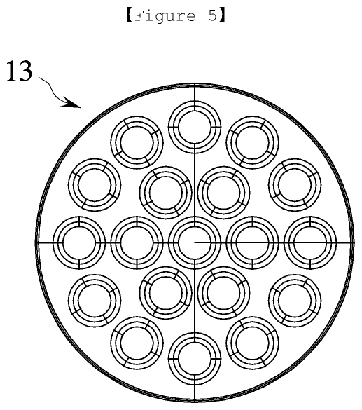

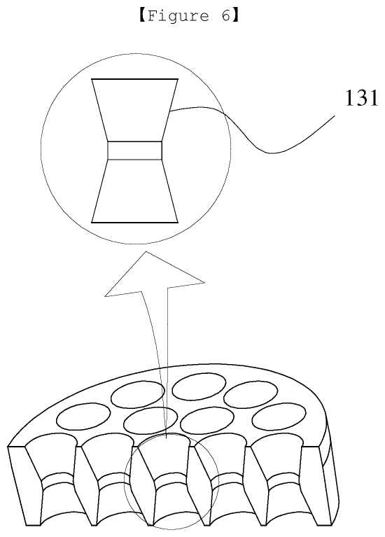

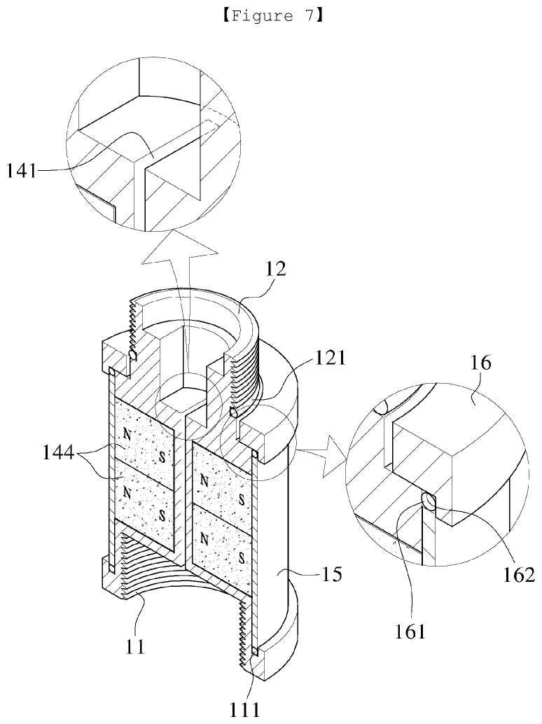

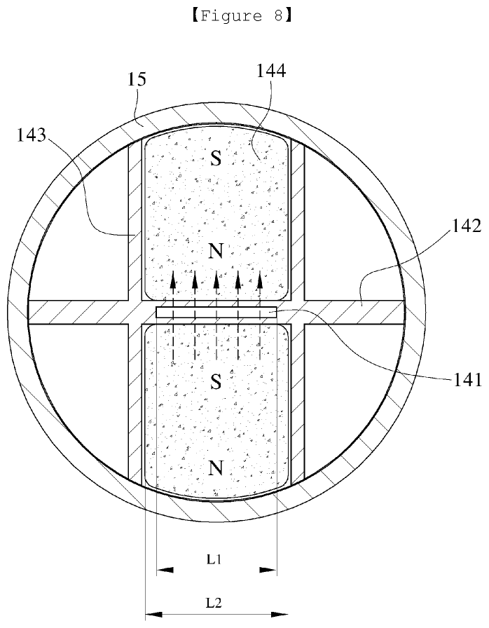

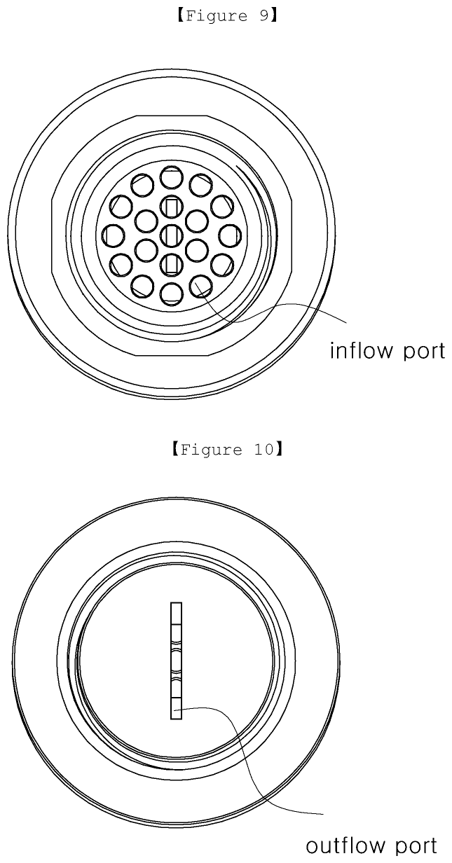

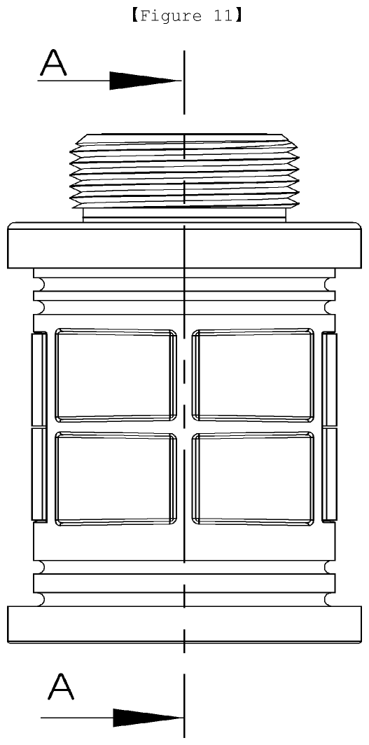

FIG. 5 is a transverse cross-sectional view showing a nozzle unit of an ionized water producing device according to an embodiment of the present invention, FIG. 6 is a partial perspective and enlarged view showing an inner state of a nozzle unit of an ionized water producing device according to an embodiment of the present invention, and FIG. 7 is a partial cut-away perspective view showing an ionized water producing device according to an embodiment of the present invention.

Referring to FIGS. 5 to 7, the nozzle unit 13 of the present invention includes a plurality of through-holes formed therein so that the nozzle unit 13 is inserted into the upper connection unit 12 to perform a primary ionization function by increasing the number of frictional rotations of water being introduced while flowing in a zigzag pattern through the inner peripheral portions 131 of the nozzle unit 13.

More specifically, the nozzle unit 13 is molded by mixing two materials in addition to precious serpentine, and is calcined at about 1050° C. to 1180° C., at which time, the inner peripheral surface of the through-hole formed in the nozzle unit 13 is formed in a shape which is gradually reduced and then again increased in diameter as it goes toward the top from the bottom like the shape of an hourglass so that the introduced water is changed in its property due o bubbles caused by pressure while passing through the through-holes, and the amount of inflow and outflow of water can be variably controlled through the number and the inner diameters of the through-holes.

In other words, the nozzle unit 13 is formed of a ceramic material and allows a phenomenon to occur in which the introduced water is soften and thus the characteristics of the water is ameliorated due to the shape, the number, and the inner diameter of the through-hole of the nozzle unit. A quantum energy is inserted into the nozzle made of precious serpentine so that when water introduced into the lower connection unit 11 flows and rotates in the nozzle inner peripheral portions 131, the energy of photons emitted from collision against the nozzle inner peripheral portions 131 creates the optimum conditions to form a primary ionizer.

The ionized water producing device 1 of the present invention can be easily mounted at various locations such as a hose connection portion of a shower, a connection portion of a washstand or a kitchen sink, and the like by forming the lower connection unit 11 and the upper connection unit 12 so that ionized water can be continuously produced by the permanent magnets.

In other words, the ionized water producing device 1 of the present invention allows water introduced through the nozzle inner peripheral portions 131 of the nozzle unit 131 to be primarily ionized by increasing the number of frictional rotations of the water while flowing in a zigzag pattern, and allows the introduced water to be secondarily ionized through the permanent magnets 144 so that ionized water of good quality can be provided.

At this time, preferably, the width L1 of the flow passage 131 formed in the main partition wall 132 positioned between both permanent magnets 134 is set to be smaller than the width L2 of each of the permanent magnets 134 so that the ionization of water can be achieved stably.

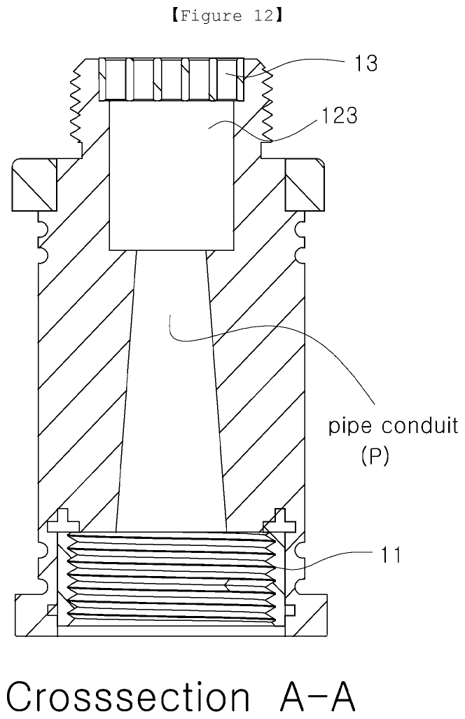

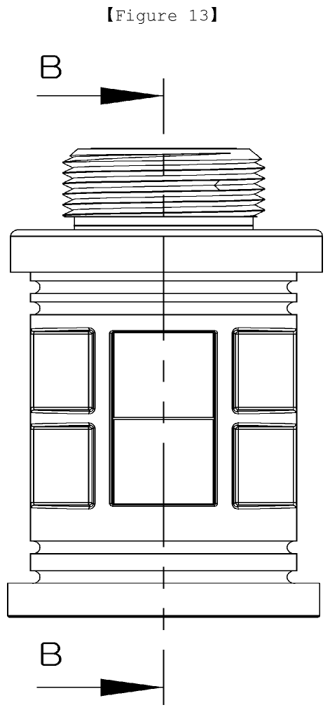

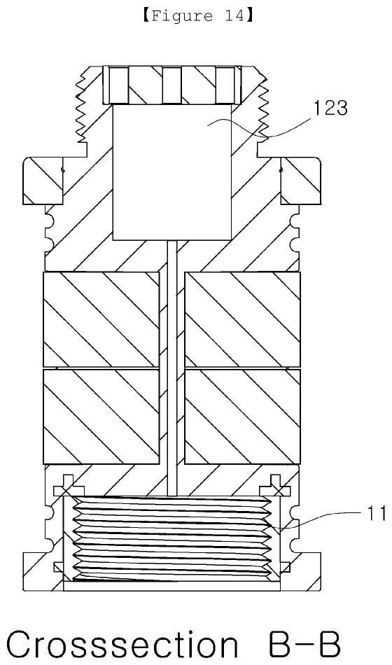

In the meantime, FIG. 11 is a front view showing an inner configuration of an ionized water producing device of the present invention, FIG. 12 is a longitudinal cross-sectional view showing an inner state of a flow channel of an ionized water producing device, taken along the line A-A of FIG. 11, and FIG. 13 is a front view showing an inner configuration of an ionized water producing device of the present invention.

Referring to FIGS. 11 to 13, the flow passage 141 allows water introduced through an inflow port of a lower portion of the housing 14 to be ionized through the permanent magnets 144 while passing therethrough so that the water is discharged to the outside through an outflow port. The inside of the flow passage 141 is configured in such a manner that the structure of an inflow port and an outflow port is formed in an inverted trapezoidal shape so that water introduced through a larger inflow port is ionized through the permanent magnets 144 and is discharged to the outside through the outflow port to provide a large amount of ionized water.

While the preferred embodiments of the present invention has been shown and described with reference to the accompanying drawings, they are merely illustrative embodiments, and the invention is not limited to these embodiments. It is to be understood by a person having an ordinary skill in the art that various equivalent modifications and variations of the embodiments can be made without departing from the spirit and scope of the present invention. Therefore, various embodiments of the present invention are merely for reference in defining the scope of the invention, and the true technical scope of the present invention should be defined by the technical spirit of the appended claims.

What is claimed is:

1. A device for producing ionized water in which water is introduced to one side thereof and vertically passes between permanent magnets with opposite polarities confronting each other to cause water to be ionized and prevent a discharge phenomenon from occurring, the device comprising:
a lower connection unit 11 opened at a bottom surface thereof and having a screw thread formed on an inner peripheral surface thereof, the lower connection unit having a stepped outer peripheral surface that is increased in outer diameter and bent upwardly at a bottom end thereof to have a first O-ring insertion groove 112 formed in the bent portion to allow a first O-ring 111 to be inserted therein;
an upper connection unit 12 opened at a top surface thereof, the upper connection unit 12 having a stepped outer peripheral surface that is reduced in outer diameter at an upper portion thereof, a second O-ring insertion groove 122 formed to be circumferentially depressed on an outer peripheral surface of an upper portion thereof to allow a second O-ring 121 to be inserted therein, and a screw thread formed on the outer peripheral surface of the upper portion thereof so as to be positioned above the second O-ring insertion groove 122;
a nozzle unit 13 having a plurality of through-holes 131 formed therein by molding and calcining precious serpentine and configured to be inserted into the upper connection unit 12 to allow the introduced water to be ionized by increasing the number of frictional rotations of the introduced water while flowing in a zigzag pattern;
a housing 14 including a main partition wall 142 formed therein in a shape of a vertically erected trapezoidal plate so as to pass through the centers of a pair of vertically spaced apart horizontal disks between the disks, the main partition wall having a flow passage 141 penetratingly formed vertically in the center thereof in a shape of an elongated hole, the housing 14 including two pairs of opposed reinforcing ribs 143, each pair of which extends outwardly from the center of the main partition wall so as to be spaced apart from each other, a pair of magnet insertion openings 145, each of which is defined by each pair of the opposed reinforcing ribs 143 and the main partition wall 142 to allow a permanent magnet to be inserted therein, and one or more horizontal reinforcing ribs 146 configured to horizontally interconnect a plurality of openings defined by the two pairs of reinforcing ribs 143 and the main partition wall 142, other than the magnet insertion openings 135, the housing 14 having a screw thread 147 formed on an inner peripheral surface thereof by insert injection molding so as to be engaged with the lower connection unit 11;
a metal tube 15 formed in a cylindrical shape and made of metal, the metal tube being configured to surround the housing 13 and pressed by the first O-ring 111 at a bottom end thereof; and
an upper end cap 16 configured to allow the upper portion of the upper connection unit 12 to penetrate through a central hole thereof so as to be exposed to the outside, the upper end cap having a bottom end that is bent downwardly at an outer peripheral surface thereof to have a third O-ring insertion groove 162 formed in the bent portion to allow a third O-ring 161 to be inserted therein to press a top end of the metal tube 15,
wherein the lower connection unit 11 includes a second engagement part 113 formed on a top surface thereof so as to be engaged with the screw thread 147 formed on the housing 14 by insert injection molding so that the flow passage 141 penetratingly extends downwardly.

2. The device according to claim 1, wherein a lower portion of the housing 13 is integrally formed with an upper portion of the lower connection unit 11 so that the flow passage 131 can be formed so as to penetratingly extend downwardly.

3. The device according to claim 1, wherein the nozzle unit 13 comprises a plurality of through-holes, and the introduced water rotates to cause bubbles to be formed by water pressure so as to be ionized while passing through a nozzle inner peripheral portion 131 formed in a shape which is gradually reduced and then again increased in diameter as it goes toward the top from the bottom.

4. The device according to claim 1, wherein the lower connection unit 11 includes: the second engagement part 113 formed protrudingly upwardly from the top surface thereof and having a screw thread formed on an outer peripheral surface thereof so as to be engaged with the first engagement part 147, the screw thread having a lower end formed with an outer peripheral surface that is steppedly decreased and increased in outer diameter; and a through-hole 116 formed vertically penetratingly at the center of the top surface of the second engagement part 113 so as to fluidically communicate with the flow passage 141 so that the second engagement part 113 is fixedly engaged with the screw thread 147 of and the housing 14.

5. The device according to claim 1, wherein the flow passage 141 allows water introduced through an inflow port of a lower portion of the housing 14 to be ionized through the permanent magnets 144 while passing through an inner pipe conduit P and then to be discharged to the outside through an outflow port, and
wherein the inside of the pipe conduit P is configured in such a manner that the structure of an inflow port and an outflow port is formed in an inverted trapezoidal shape so that water introduced through the inflow port is ionized through the permanent magnets 144 and is discharged to the outside through the outflow port to provide a large amount of ionized water.
